(19) United States
(12) Patent Application Publication
(10) Pub. No.: US 2025/0389894 A1
(43) Pub. Date: Dec. 25, 2025

(54) METHOD OF MANUFACTURING AN OPTICAL RIB WAVEGUIDE

(71) Applicant: STMicroelectronics International N.V., Geneva (CH)

(72) Inventors: Frédéric Boeuf, St Nazaire les Eymes (FR); Stephane Monfray, Eybens (FR); Sébastien Cremer, Sassenage (FR)

(21) Appl. No.: 19/246,543

(22) Filed: Jun. 23, 2025

(30) Foreign Application Priority Data
Jun. 25, 2024 (FR) FR2406802

(51) Int. Cl. G02B 6/136; G02B 6/12

(52) U.S. Cl. CPC G02B 6/136; G02B 2006/12097

(57) ABSTRACT

According to one aspect, a method for manufacturing a ridge waveguide of a photonic integrated circuit is proposed, the method including formation of an initial ridge optical waveguide structure from a layer of silicon formed on a layer of insulator, then formation of a mask having an opening facing a ridge of the initial structure, then oxidation implemented so as to reduce the thickness of the ridge of the initial structure located facing the opening of the mask, in order to obtain, from the initial structure, an optical waveguide having a ridge with a thickness less than the thickness of the ridge of the initial structure, then removal of the mask.

### CROSS-REFERENCE TO RELATED APPLICATIONS

This application claims the priority to French Application No. FR2406802, filed on Jun. 25, 2024, which application is hereby incorporated herein by reference.

### TECHNICAL FIELD

Embodiments and implementations relate to integrated circuits configured to propagate optical waves.

### BACKGROUND

Optical integrated circuits (“photonic integrated circuits”) are circuits configured to propagate light.

Photonic integrated circuits that use silicon as base material for manufacturing optical components are known in particular. These photonic integrated circuits can be designated by the expression “SiPho”, from the English “Silicon Photonics”.

In particular, integrated circuits of the “SiPho” type use the compatibility of silicon with the methods for manufacturing semiconductors to create optical components. This allows effective integration with electronic circuits.

Integrated circuits of the “SiPho” type comprise in particular optical waveguides. These optical waveguides make it possible to direct and manipulate light inside photonic integrated circuits. These optical waveguides are essentially silicon structures that confine and convey the light from one point to another.

Range or rib waveguides are known in particular, which are optical structures that are particularly common in technologies based on semiconductors, such as devices based on III-V materials (materials composed of one or more elements in column III and column V of the Mendeleev periodic table), such as gallium arsenide (GaAs) or indium phosphide (InP). Ridge waveguides are used in a variety of applications, including semiconductor lasers, optical modulators, photodiode detectors, and other integrated optical components. They are particularly adapted to devices requiring confinement of light in a specific direction.

A ridge waveguide comprises a strip layer (“slab”), a sheath layer (cladding) and a ridge or rib projectingly surmounting the slab, the ridge having a width less than that of the slab. The ridge waveguide can be produced from a layer of silicon on insulator.

The thickness of the ridge of a ridge waveguide is defined by the initial thickness of the layer of silicon on insulator. However, for certain photonic integrated circuits, the optimum thickness of the ridge of a ridge waveguide is different from the initial thickness of the layer of silicon on insulator. In particular, the thickness of the ridge impacts directly on the propagation index of the ridge. For example, in a hybrid laser, the coupling between a stack of “III-V” materials (materials composed of one or more elements in column III and column V of the Mendeleev periodic table) and the silicon on insulator requires a ridge thickness of 500 nanometers. In a PN junction of a modulator, the capacitance is optimised by using a ridge with a thickness of between 150 nanometers and 310 nanometers. In a fibre-grating coupler, optimum efficacy is obtained using a ridge with a thickness of the order of 300 nanometers.

### SUMMARY

### Brief Description of the Drawings

Other advantages and features of the invention will become apparent upon reading the detailed description of embodiments, which are in no way limiting, and from the appended drawings in which:

FIG. 1 illustrates a view in cross section of an embodiment of an integrated circuit;

FIG. 2 illustrates a three-dimensional view of an embodiment of a part of a waveguide;

FIG. 3 illustrates an embodiment of the method for manufacturing an integrated circuit;

FIG. 4 illustrates an initial structure in accordance with an embodiment;

FIGS. 5(a) and 5(b) illustrate an initial ridge waveguide structure and a hard mask that can be obtained at the end of the formation of the hard mask;

FIGS. 6(a) and 6(b) illustrate a ridge waveguide and a hard mask that can both be obtained at the end of the depositing of the dielectric thickness above the ridge of the ridge waveguide; and

FIGS. 7(a), 7(b) and 7(c) illustrate a ridge waveguide that can be obtained at the end of the removal of the hard mask.

### DETAILED DESCRIPTION OF ILLUSTRATIVE EMBODIMENTS

Embodiments provide solutions making it possible to provide ridge optical waveguides having different thicknesses in one and the same semiconductor wafer in order to integrate, in one and the same integrated circuit, devices requiring different ridge thicknesses in one and the same semiconductor wafer to optimise the performances thereof.

In particular, a known method for manufacturing a ridge waveguide comprises first of all an initial etching step for defining a new thickness of the layer of silicon on insulator as well as ridges of waveguides having a thickness greater than the new thickness of the layer of silicon. Next, the method comprises a step of photolithography and then etching in order to locally reduce the thickness of the slab and to define new ridge-waveguide ridges having the thickness of the layer of silicon on insulator obtained by the initial etching step. Next, the manufacturing method comprises a step of depositing a layer of insulator, in particular of silicon dioxide, as far as the surface of the ridges having the greatest thickness.

Such a solution has the drawback of obtaining significant roughness on the surface of the ridges, because the latter are defined by etching. Such roughness degrades the propagation of the optical waves in the waveguide. Furthermore, the etching implemented after the photolithography has low resolution. Thus the ridges defined by this etching have significant edge-of-line roughness, which also degrades the propagation of the optical waves.

Moreover, the thickness of the ridges defined by the etching that follows the photolithography corresponds to the thickness of the layer of silicon on insulator obtained after the initial etching step. Such a manufacturing method does not make it possible to have a ridge thickness different from the thickness of the silicon on insulator layer obtained after the initial etching step.

According to one aspect, a method for manufacturing a ridge waveguide of a photonic integrated circuit is proposed, the method comprising: formation of an initial ridge optical waveguide structure from a layer of silicon formed on a layer of insulator, then formation of a mask having an opening facing a ridge of said initial structure, then oxidation implemented so as to reduce the thickness of the ridge of said initial structure located facing said opening of the mask, in order to obtain, from said initial structure, an optical waveguide having a ridge with a thickness less than the thickness of the ridge of the initial structure, then removal of the mask.

In such a manufacturing method, the height of the ridge of the ridge waveguide is defined after having formed an initial ridge-waveguide structure. In particular, the height of the ridge of the ridge waveguide is adjusted by oxidation after having formed said initial ridge-waveguide structure.

Such a manufacturing method has the advantage of maintaining relatively low roughness on the surface of the ridge of a ridge waveguide. For example, the surface roughness of the ridge can be less than 2.5 nanometers. This is because the photolithography implemented has high definition, which makes it possible to obtain low roughness, and the thickness of the ridge is reduced by oxidation, which does not add any surface roughness.

Furthermore, such a manufacturing method makes it possible to locally reduce the thickness of a ridge of a ridge waveguide so as to preserve a greater thickness of silicon on insulator for other components of the photonic integrated circuit for which this greater thickness makes it possible to obtain better performances. Thus such a method makes it possible to manufacture a ridge waveguide with a thickness different from the initial thickness of the silicon on insulator.

In an advantageous embodiment, the mask is formed so that the mask covers at least a transition portion of the ridge of the initial structure and so that the opening of the mask is facing a main portion of the ridge of the initial structure, said at least one transition portion longitudinally extending the main portion.

In this way, the oxidation makes it possible to reduce only the thickness of the main portion of the ridge.

In such an embodiment, the adjustment of the thickness of the main portion and the formation of said at least one transition portion of the ridge waveguide are implemented simultaneously.

In an advantageous embodiment, said at least one transition portion has a width decreasing towards the main portion of the ridge of the ridge waveguide.

Advantageously, said at least one transition portion has a point shape directed towards the main portion of the ridge of the ridge waveguide.

Preferably, the formation of the initial structure comprises photolithography of the layer of silicon on the layer of insulator so as to form: a slab of the initial structure, and said ridge on said slab.

Advantageously, said photolithography is implemented so as to define a final thickness of the slab for said ridge waveguide.

Such an embodiment has the advantage of allowing independent definition of the thickness of the slab and of the thickness of the ridge.

In an advantageous embodiment, the method comprises, before the formation of said mask, formation of a dielectric cladding on said initial structure, said dielectric cladding having an opening facing the ridge of said initial structure.

Advantageously, the method comprises, before the formation of said mask, chemical mechanical polishing adapted to reduce the thickness of the dielectric cladding.

Preferably, the method furthermore comprises removing the oxide obtained by said oxidation and then depositing a dielectric cladding on the ridge of the ridge waveguide before the mask is removed.

Advantageously, the slab is formed so as to have a thickness of between 50 nanometers and 150 nanometers.

Preferably, the oxidation is implemented so that the ridge of the ridge waveguide has a thickness of between 100 nanometers and 230 nanometers.

According to another aspect, an integrated circuit is proposed comprising a ridge optical waveguide obtained by implementing a manufacturing method as described previously.

Thus an integrated circuit is proposed comprising a ridge optical waveguide having a surface roughness of the ridge of less than 2.5 nanometers.

Advantageously, the integrated circuit furthermore comprises at least one optical waveguide having a different thickness compared with the thickness of the ridge of the ridge waveguide.

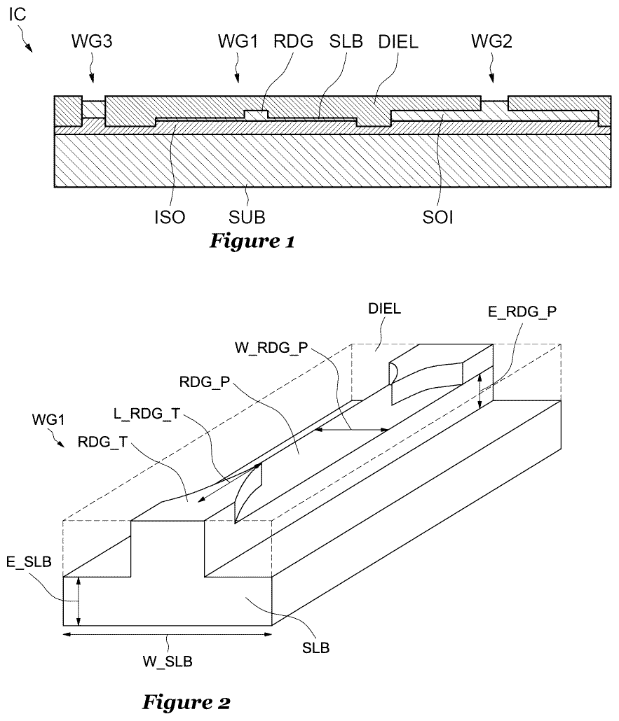

FIG. 1 illustrates a view in cross section of an embodiment of an integrated circuit IC. This integrated circuit IC comprises a support substrate SUB, a layer of insulator ISO on the support substrate layer SUB, a layer of silicon SOI on the layer of insulator ISO, and a dielectric cladding DIEL. The layer of silicon SOI is used to form optical waveguides WG1, WG2, WG3 and other electronic components (not shown).

The layer of insulator ISO is formed from a dielectric material, for example from silicon dioxide. The layer of insulator ISO conventionally has a thickness of between 700 nanometers and 5 micrometers.

The layer of silicon SOI on the insulator ISO is a layer that can be designated by the English expression “Silicon on Insulator”.

The optical waveguides WG1, WG2, WG3 are formed in the layer of silicon SOI on the insulator ISO. These waveguides WG1, WG2, WG3 can be juxtaposed with other waveguides so that the light can propagate between these waveguides.

FIG. 2 illustrates a three-dimensional view of an embodiment of a part of a waveguide WG1. The optical waveguide WG1 is a ridge or rib waveguide. This optical waveguide WG1 therefore comprises a slab SLB. The slab SLB corresponds to a planar part of the ridge waveguide. The slab SLB has a thickness E_SLB of between 50 nanometers and 150 nanometers. The thickness E_SLB of the slab SLB can vary between the various optical waveguides WG1 and WG2. The slab SLB has a width W_SLB sufficiently great for the optical waveguide not to extend beyond its ends and adapted to avoid interactions with other waveguides. For example, the width W_SLB of the slab SLB is between 2 μm and 5 μm.

The ridge waveguide WG1 also comprises a ridge RDG surmounting the slab SLB. This ridge RDG is formed from the same layer of silicon SOI as the slab SLB. This ridge RDG extends longitudinally over the slab SLB.

The ridge RDG can have a main portion RDG_P as well as at least one transition portion RDG_T extending as far as a longitudinal end of the ridge. Said at least one transition portion RDG_T has a form adapted to improve the propagation of the waves between said at least one transition portion RDG_T and the main portion RDG_P.

Said at least one transition portion RDG_T has a point shape in the longitudinal direction of the ridge RDG, the point being oriented towards said main portion RDG_P. The transition portion RDG_T therefore has a width that decreases over its length as far as the main portion.

The main portion RDG_P of the ridge RDG has a thickness E_RDG_P less than the thickness E_RDG_T of said at least one transition portion RDG_T. In particular, the main portion RDG_P has a thickness E_RDG_P of between 100 nanometers and 230 nm.

The main portion RDG_P has a width W_RDG_P of between 300 nanometers and 2 micrometers, in particular between 300 nanometers and 800 nanometers.

The transition portion RDG_T make it possible to improve propagation of the waves between the main portion RDG_P and other waveguides extending this waveguide in a ridge WG1 and having a thickness corresponding to the thickness of said at least one transition portion RDG_T.

The transition portion RDG_T has a length L_RDG_T of between 500 nanometers and 5 micrometers, for example of the order of 1 micrometre.

The ridge RDG and the slab SLB of the ridge waveguide have low roughness, in particular less than 2.5 nanometers.

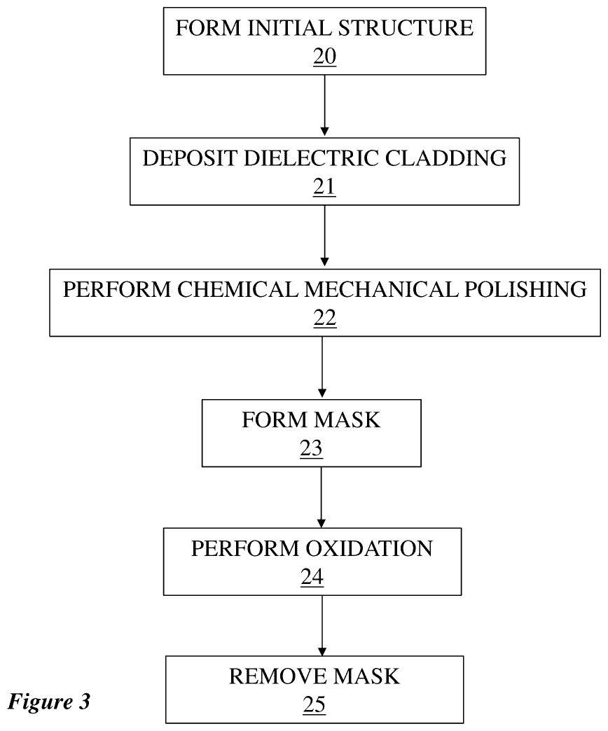

FIG. 3 illustrates an embodiment of the method for manufacturing an integrated circuit such as the one illustrated in FIG. 1.

The method comprises a step 20 of forming an initial structure STR of a ridge waveguide from a semiconductor slice WFR (which can also be referred to by the term “wafer”). This wafer WFR comprises a substrate SUB, an insulating layer ISO on the substrate layer SUB and a layer of silicon SOI on the insulating layer ISO. The silicon layer SOI can have a thickness of 300 nanometers for example.

The initial structure STR is used to then obtain a ridge waveguide WG1 as described previously.

The initial waveguide structure STR is formed from the layer of silicon SOI by implementing high-resolution photolithography. This makes it possible to obtain low line-edge roughness.

The initial structure STR comprises a slab SLB, a ridge RDG and a sheath layer (including in particular the layer of insulator ISO and the dielectric cladding DIEL). The ridge RDG has a thickness corresponding to the initial thickness of the layer of silicon SOI on the insulator ISO. This thickness is then greater than a required thickness for the ridge RDG.

The formation of the initial structure STR nevertheless makes it possible to define the required thickness of the slab SLB of the ridge waveguide.

The method also comprises a step 21 of depositing a dielectric cladding DIEL on the wafer, in particular on the initial optical-waveguide structure STR. This dielectric cladding DIEL is formed so as to have an opening facing the ridge RDG of the initial optical-waveguide structure STR for which a reduction in thickness of the ridge RDG is required. This dielectric cladding DIEL can in particular be produced from silicon dioxide.

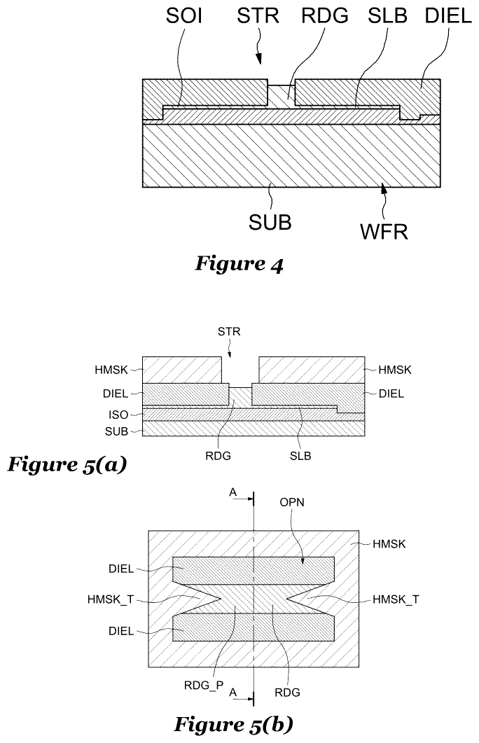

An embodiment of such an initial structure STR is illustrated in FIG. 4.

The method also comprises a chemical mechanical polishing step 22 for reducing the thickness of the dielectric cladding DIEL so that the top surface thereof extends to a height slightly higher than the height of the ridge RDG of the initial structure STR of the ridge waveguide. For example, the height of the top surface of the dielectric cladding DIEL is greater than the height of the ridge RDG by a distance of between 1 nanometre and 20 nanometers. This chemical mechanical polishing step 22 makes it possible to adjust the thickness of the dielectric cladding.

This chemical mechanical polishing step 22 also makes it possible to obtain an electrical cladding having a smooth top surface so as to simplify the application of the hard mask MSK, as described hereinafter.

Once the chemical mechanical polishing has been implemented, a fine layer of silicon oxide can be preserved on the ridge RDG in order to avoid damaging the waveguide.

The method comprises a step 23 of forming a hard mask HMSK on the dielectric cladding DIEL. A hard mask HMSK corresponds to a layer manufactured from a robust durable material, this layer having an opening OPN predefined form. The hard mask HMSK can in particular be produced from SiN. The hard mask HMSK can be obtained by depositing a layer of SiN followed by photolithography and etching to obtain the opening OPN.

In particular, the hard mask HMSK is formed so as to have an opening OPN facing a main portion RDG_P of the ridge RDG of the initial ridge waveguide structure STR for which a reduction in thickness of the ridge RDG is required. The hard mask HSMSK is also formed so as to cover at least a transition portion RDG_T of the ridge of the initial ridge waveguide structure STR.

More particularly, the opening of the mask HMSK has a width greater than the width of the ridge RDG in order to compensate for faulty photolithography alignment and to use a low-cost low-resolution mask.

FIGS. 5(a) and 5(b) illustrate an initial ridge waveguide structure STR and a hard mask HMSK that can be obtained at the end of the formation of the hard mask HMSK. In particular, FIG. 5(b) is a plan view of the ridge waveguide and FIG. 5(a) is a view in cross section along the plane A-A illustrated on FIG. 5(b).

The method furthermore comprises an oxidation step 24. Oxidation makes it possible to transform into silicon oxide part of the surface silicon of the ridge RDG of the initial structure STR. This therefore makes it possible to reduce the thickness of the ridge RDG of the waveguide on its part not covered by the mask HMSK.

The duration of oxidation makes it possible to define the final thickness of the ridge RDG of the waveguide.

The oxidation step makes it possible to obtain a ridge waveguide WG1 having a ridge RDG having a main portion RDG_P and at least one transition portion RDG_T, the main portion RDG_P having a thickness less than the thickness of said at least one transition portion RDG_T.

The silicon oxide generated by the oxidation can then be removed or not. A thickness of dielectric DIEL, in particular of silicon dioxide, is also deposited to fill the opening in the cladding above the ridge of the ridge waveguide that was subjected to said oxidation. The method can next comprise a chemical mechanical polishing step.

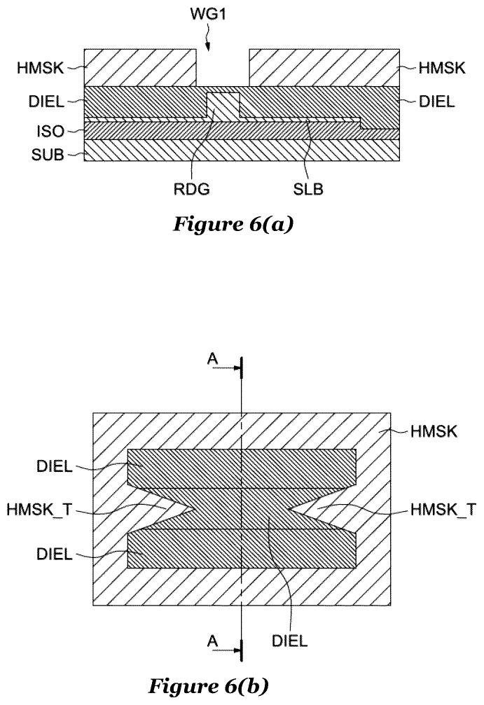

FIGS. 6(a) and 6(b) illustrate a ridge waveguide WG1 and a hard mask HMSK that can both be obtained at the end of the depositing of the dielectric thickness DIEL above the ridge of the ridge waveguide. In particular, FIG. 6(b) is a plan view of the ridge waveguide and FIG. 6(a) is a view in cross section along the plane A-A illustrated on FIG. 6(b).

The method next comprises a step 25 of removing the mask HMSK.

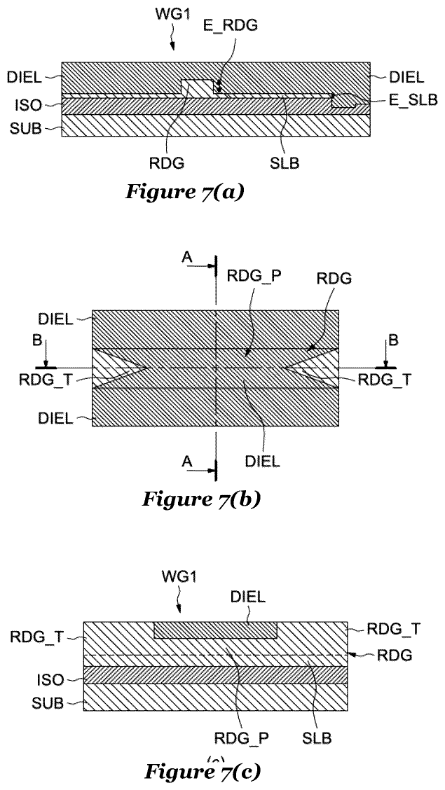

FIGS. 7(a), 7(b) and 7(c) illustrate a ridge waveguide that can be obtained at the end of the removal of the hard mask HMSK. In particular, FIG. 6(b) is a plan view of the ridge waveguide, FIG. 7(a) is a view in cross section along the plane A-A illustrated on FIG. 7(b), and FIG. 7(c) is a view in longitudinal section along the plane B-B on FIG. 7(b).

Steps 23 to 25 can be repeated to define waveguides having ridges with different thicknesses.

Such a manufacturing method can be used for manufacturing an integrated circuit such as the one illustrated in FIG. 1.

In such a manufacturing method, the height of the ridges of a ridge waveguide is defined after having previously formed an initial ridge-waveguide structure. In particular, the height of the ridge of the ridge waveguide is adjusted by oxidation after having formed the initial ridge-waveguide structure.

Furthermore, in such a manufacturing method, the adjustment of the thickness of the main portion and the formation of said at least one transition portion of a ridge waveguide are implemented simultaneously.

Such a manufacturing method has the advantage of maintaining relatively low roughness on the surface of the ridges of the ridge waveguides. For example, the surface roughness of the ridge can be less than 2.5 nanometers. This is because the photolithography implemented has high definition, which makes it possible to obtain low roughness, and the thickness of the ridge is reduced by oxidation, which does not add any surface roughness.

Such a manufacturing method also has the advantage of making it possible to define independently a thickness of the slab and a thickness of the ridge.

What is claimed is:

1. A method for manufacturing a ridge waveguide of a photonic integrated circuit, the method comprising:
forming an initial structure for an optical ridge waveguide from a layer of silicon formed on a layer of insulator;
forming a mask having an opening facing a ridge of the initial structure;
performing an oxidation process with the mask so as to reduce the thickness of the ridge of the initial structure located facing the opening of the mask, the performing forming, from the initial structure, the optical ridge waveguide having a ridge with a thickness less than the thickness of the ridge of the initial structure; and
removing the mask after performing the oxidation process.

2. The method according to claim 1, wherein the mask is formed so that the mask covers at least a transition portion of the ridge of the initial structure and so that the opening of the mask is facing a main portion of the ridge of the initial structure, the at least one transition portion longitudinally extending the main portion.

3. The method according to claim 2, wherein the at least one transition portion has a width decreasing towards the main portion of the ridge of the ridge waveguide.

4. The method according to claim 3, wherein the at least one transition portion has a point shape directed towards the main portion of the ridge of the ridge waveguide.

5. The method according to claim 1, wherein the formation of the initial structure comprises photolithography of the layer of silicon on the layer of insulator so as to form:
a slab of the initial structure; and
the ridge on the slab.

6. The method according to claim 5, wherein the photolithography is implemented so as to define a final thickness of the slab for the ridge waveguide.

7. The method according to one of claim 1, further comprising, before forming the mask, forming a dielectric cladding on the initial structure, the dielectric cladding having an opening facing the ridge of the initial structure.

8. The method according to claim 7, comprising, before the formation of the mask (HMSK), chemical mechanical polishing adapted to reduce the thickness of the dielectric cladding (DIEL).

9. The method according to one of claim 1, furthermore comprising removing the oxide obtained by the oxidation and then depositing a dielectric cladding on the ridge of the ridge waveguide before the mask is removed.

10. The method according to claim 5, wherein the slab is formed so as to have a thickness of between 50 nanometers and 150 nanometers.

11. The method according to claim 1, wherein the oxidation is performed so that the ridge of the ridge waveguide has a thickness of between 100 nanometers and 230 nanometers.

12. The method according to claim 1, furthermore comprising forming at least one optical waveguide having a different thickness compared with the thickness of the ridge of the ridge waveguide.

13. A method for manufacturing a photonic integrated circuit having multiple ridge waveguides with different thicknesses, the method comprising:
having a silicon-on-insulator structure comprising a substrate, an insulator layer on the substrate, and a silicon layer on the insulator layer;
performing photolithography on the silicon layer to form a plurality of initial ridge waveguide structures, each initial ridge waveguide structure comprising a slab and a ridge on the slab;
depositing a dielectric cladding on the plurality of initial ridge waveguide structures;
performing chemical mechanical polishing to reduce a thickness of the dielectric cladding;
forming a hard mask on the dielectric cladding, the hard mask having openings facing ridges of selected initial ridge waveguide structures;
performing an oxidation process to reduce the thickness of the ridges facing the openings of the hard mask; and
removing the hard mask.

14. The method according to claim 13, wherein the hard mask comprises silicon nitride.

15. The method according to claim 13, wherein the dielectric cladding comprises silicon dioxide.

16. The method according to claim 13, wherein the oxidation process is performed for a duration selected to achieve predetermined final thicknesses of the ridges facing the openings of the hard mask.

17. An integrated circuit comprising:
a ridge optical waveguide having a surface roughness of the ridge of less than 2.5 nanometers.

18. The integrated circuit according to claim 17, further comprising at least one optical waveguide having a different thickness compared with the thickness of the ridge of the ridge waveguide.

19. The integrated circuit according to claim 17, wherein the ridge optical waveguide comprises:
a slab having a thickness between 50 nanometers and 150 nanometers; and
a ridge on the slab, the ridge having a thickness between 100 nanometers and 230 nanometers.

20. The integrated circuit according to claim 17, wherein the ridge optical waveguide comprises:
a main portion having a first thickness; and
at least one transition portion having a second thickness different than the first thickness, the at least one transition portion having a width that decreases toward the main portion.
